(19) United States
(12) Patent Application Publication
(10) Pub. No.: US 2022/0343332 A1
(43) Pub. Date: Oct. 27, 2022

(54) TRANSACTION VERIFICATION METHOD, AND SYSTEM

(71) Applicant: CIENET TECHNOLOGIES (NANJING) CO., LTD., Nanjing (CN)

(72) Inventor: Yuance DENG, Nanjing (CN)

(73) Assignee: CIENET TECHNOLOGIES (NANJING) CO., LTD., Nanjing (CN)

(21) Appl. No.: 17/809,897

(22) Filed: Jun. 30, 2022

Related U.S. Application Data
(63) Continuation of application No. PCT/CN2020/140347, filed on Dec. 28, 2020.

(30) Foreign Application Priority Data
Dec. 30, 2019 (CN) 201911388260.X

(51) Int. Cl. G06Q 20/40; G06Q 20/32

(52) U.S. Cl. CPC G06Q 20/4016; G06Q 20/407; G06Q 20/4015; G06Q 20/3276

(57) ABSTRACT

Disclosed are a transaction verification method and a system. The method comprises: receiving request information for launching a transaction page that is sent by a user terminal, the request information for launching the transaction page comprising current position information of the user terminal and region restriction information pre-configured for the transaction page; verifying, according to the current position information of the user terminal and the region restriction information, a transaction action corresponding to the request information for the transaction page; if the transaction action corresponding to the request information for the transaction page is verified successfully, performing a transaction page response, and sending the transaction page to the user terminal, so as to enable the user terminal to perform the transaction action; and if the transaction action corresponding to the request information for the transaction page does not pass the verification, ending a transaction page response.

### BACKGROUND

### Technical Field

The present invention relates to a transaction verification method and also relates to a corresponding transaction verification system, and belongs to the technical field of electronic transactions.

### Related Art

Currently, with the development of mobile communication technologies, a new technology that uses a payment code (such as a two-dimensional code and a barcode) as an information carrier is rapidly accepted by people and the market. Payment methods based on two-dimensional codes or barcodes are widely accepted and favored by the public. In addition, for example, a two-dimensional code is not limited to payment and circulation of money, but is extended to circulation of some non-standard assets. For example, a merchant provides a specific two-dimensional code for scanning to obtain a discount coupon.

In some specific scenarios, both parties involved in scanning a two-dimensional code for payment or obtaining information are required in a specific area, such as a scenario in which a face-to-face transaction is required. For example, to attract offline customer traffic for a specific entity store, an activity for scanning a specific two-dimensional code of the entity store to obtain a discount coupon is proposed. However, a current payment mechanism does not perform area verification on locations of both payment parties. Therefore, it cannot be ensured that a transaction is completed in a specific area, and therefore, a malicious transaction, a fake order, and tax evasion are easily triggered in a non-specific area.

### SUMMARY

A first technical problem to be resolved in the present invention is to provide a transaction verification method.

Another technical problem to be solved in the present invention is to provide a transaction verification system.

To achieve the objective, the following technical solutions are used in the present invention.

According to a first aspect of the embodiments of the present invention, a transaction verification method is provided, including:

receiving request information for starting a transaction page that is sent by a user terminal, where the request information for starting a transaction page includes current location information of the user terminal and area limitation information preconfigured for the transaction page;

verifying, according to the current location information of the user terminal and the area limitation information, a transaction behavior corresponding to the request information for starting a transaction page; and

when verification on the transaction behavior corresponding to the request information for starting a transaction page succeeds, making a transaction page response, and sending the transaction page to the user terminal, so that the user terminal performs the transaction behavior; and when verification on the transaction behavior corresponding to the request information for starting a transaction page fails, terminating the transaction page response.

Preferably, the receiving request information for starting a transaction page that is sent by a user terminal includes:

receiving request information for starting a transaction page that is generated by the user terminal by scanning a transaction code, where the request information for starting a transaction page includes current location information of the user terminal and area limitation information preconfigured for the transaction page, and the area limitation information includes preconfigured location information of a merchant source terminal.

Preferably, the transaction code includes a two-dimensional code; the current location information of the user terminal includes a current longitude and latitude of the user terminal; and the preconfigured location information of the merchant source terminal includes a preconfigured longitude and latitude of the merchant source terminal; and

the receiving request information for starting a transaction page that is generated by the user terminal by scanning a transaction code includes:

receiving request information for starting a transaction page that is generated by the user terminal by scanning a two-dimensional code, where the preconfigured longitude and latitude of the merchant source terminal in the request information for starting a transaction page are from the two-dimensional code; and the two-dimensional code is generated according to a URL link after the preconfigured longitude and latitude of the merchant source terminal are embedded in the URL link in the request information for starting a transaction page.

Preferably, the transaction code includes a two-dimensional code; the current location information of the user terminal includes a current longitude and latitude of the user terminal; and the preconfigured location information of the merchant source terminal includes a preconfigured longitude and latitude of the merchant source terminal; and

the verifying, according to the current location information of the user terminal and the area limitation information, a transaction behavior corresponding to the request information for starting a transaction page includes:

determining a relative distance between the current longitude and latitude of the user terminal and the preconfigured longitude and latitude of the merchant source terminal according to the current longitude and latitude of the user terminal and the preconfigured longitude and latitude of the merchant source terminal; and

verifying, according to the relative distance and a preset distance threshold, the transaction behavior corresponding to the request information for starting a transaction page; and when the relative distance is less than or equal to the preset distance threshold, determining that verification on the transaction behavior corresponding to the request information for starting a transaction page succeeds; or when the relative distance is greater than the preset distance threshold, determining that verification on the transaction behavior corresponding to the request information for starting a transaction page fails.

Preferably, the determining a relative distance between the current longitude and latitude of the user terminal and the preconfigured longitude and latitude of the merchant source terminal according to the current longitude and latitude of the user terminal and the preconfigured longitude and latitude of the merchant source terminal includes:

determining a latitude difference α and a longitude difference β between the current longitude and latitude of the user terminal and the preconfigured longitude and latitude of the merchant source terminal according to the current longitude and latitude {LatitB, LongitB} of the user terminal and the preconfigured longitude and latitude {LatitA, LongitA} of the merchant source terminal by using a formula:

$$\{ \begin{matrix}α = deg 2 rad ( LatitA ) - deg 2 rad ( LatitB ) \\ β = deg2rad ( LongitA ) - deg 2 rad ( LongitB ) ,\end{matrix}$$

where LatitB is the current latitude of the user terminal, LongitB is the current longitude of the user terminal, LatitA is the preconfigured latitude of the merchant source terminal, and LongitA is the preconfigured longitude of the merchant source terminal; and deg2rad(x) represents an angle conversion radian function, where

$$deg 2 rad ( x ) = \frac{π}{180} \cdot x ;$$

and

determining, according to the latitude difference α and the longitude difference β, a relative distance S between the current longitude and latitude of the user terminal and the preconfigured longitude and latitude of the merchant source terminal;

where,

$$S = 2 * arcsin \sqrt{{( sin \frac{α}{2} )}^{2} + cos ( LongitA ) * cos ( LongitB ) * {( sin \frac{β}{2} )}^{2}} * R ,$$

and R is an equivalent earth radius.

According to a second aspect of the embodiments of the present invention, a transaction verification system is provided, including a server and a user terminal, where the user terminal is communicatively connected to the server; and

the server is configured to receive request information for starting a transaction page that is sent by a user terminal, where the request information for starting a transaction page includes current location information of the user terminal and area limitation information preconfigured for the transaction page; verify, according to the current location information of the user terminal and the area limitation information, a transaction behavior corresponding to the request information for starting a transaction page; when verification on the transaction behavior corresponding to the request information for starting a transaction page succeeds, make a transaction page response, and send the transaction page to the user terminal, so that the user terminal performs the transaction behavior; and when verification on the transaction behavior corresponding to the request information for starting a transaction page fails, terminate the transaction page response.

Preferably, the transaction verification system further includes a merchant source terminal communicatively connected to the server; and

the user terminal is configured to scan a transaction code provided by the merchant source terminal, generate and send request information for starting a transaction page to the server, where the request information for starting a transaction page includes current location information of the user terminal and area limitation information preconfigured for the transaction page, and

the area limitation information includes preconfigured location information of the merchant source terminal.

Preferably, the transaction code includes a two-dimensional code; the current location information of the user terminal includes a current longitude and latitude of the user terminal; and the preconfigured location information of the merchant source terminal includes a preconfigured longitude and latitude of the merchant source terminal; and

the merchant source terminal is specifically configured to embed the preconfigured longitude and latitude of the merchant source terminal into a URL link of the request information for starting a transaction page, and generate the two-dimensional code according to the URL link; and

the user terminal is specifically configured to scan a two-dimensional code provided by the merchant source terminal, generate request information for starting a transaction page, and send the request information for starting a transaction page to the server.

Preferably, the transaction code includes a two-dimensional code; the current location information of the user terminal includes a current longitude and latitude of the user terminal; and the preconfigured location information of the merchant source terminal includes a preconfigured longitude and latitude of the merchant source terminal; and

the server is specifically configured to:

determine a relative distance between the current longitude and latitude of the user terminal and the preconfigured longitude and latitude of the merchant source terminal according to the current longitude and latitude of the user terminal and the preconfigured longitude and latitude of the merchant source terminal; and

verify, according to the relative distance and a preset distance threshold, the transaction behavior corresponding to the request information for starting a transaction page; and when the relative distance is less than or equal to the preset distance threshold, determine that verification on the transaction behavior corresponding to the request information for starting a transaction page succeeds; or when the relative distance is greater than the preset distance threshold, determine that verification on the transaction behavior corresponding to the request information for starting a transaction page fails.

Preferably, the server is configured to: determine a latitude difference α and a longitude difference β between the current longitude and latitude of the user terminal and the preconfigured longitude and latitude of the merchant source terminal according to the current longitude and latitude {LatitB, LongitB} of the user terminal and the preconfigured longitude and latitude {LatitA, LongitA} of the merchant source terminal by using a formula:

$$\{ \begin{matrix}α = deg 2 rad ( LatitA ) - deg 2 rad ( L a titB ) \\ β = deg 2 rad ( L o n gitA ) - deg 2 rad ( L o n gitB )\end{matrix} ,$$

where LatitB is the current latitude of the user terminal, LongitB is the current longitude of the user terminal, LatitA is the preconfigured latitude of the merchant source terminal, and LongitA is the preconfigured longitude of the merchant source terminal; and deg2rad(x) represents an angle conversion radian function, where

$$deg 2 rad ( x ) = \frac{π}{180} \cdot x ;$$

and

determine, according to the latitude difference α and the longitude difference β, a relative distance S between the current longitude and latitude of the user terminal and the preconfigured longitude and latitude of the merchant source terminal;

where,

$$S = 2 * arcsin \sqrt{{( sin \frac{α}{2} )}^{2} + cos ( LongitA ) * cos ( LongitB ) * {( sin \frac{β}{2} )}^{2}} * R ,$$

and R is an equivalent earth radius.

According to the transaction verification method and system provided in the present invention, the current location information of the user terminal and the area limitation information preconfigured for the transaction page can be obtained from the request information for starting a transaction page that is sent by the user terminal. Further, the transaction behavior corresponding to the request information for starting a transaction page may be verified. In this way, a transaction can be completed in a specific area, and a malicious transaction, a fake order, and tax evasion in a non-specific area can be avoided.

### BRIEF DESCRIPTION OF THE DRAWINGS

FIG. 1 is a schematic structural diagram of hardware of an optional mobile terminal according to embodiments of the present invention;

FIG. 2 is a flowchart 1 of a transaction verification method according to the present invention;

FIG. 3 is a second flowchart of a transaction verification method according to the present invention;

FIG. 4 is a schematic structural diagram of a transaction verification apparatus according to the present invention; and

FIG. 5 is a schematic structural diagram of a transaction verification system according to the present invention.

### DETAILED DESCRIPTION

Technical contents of the present invention are further described in detail below with reference to the accompanying drawings and specific embodiments.

To make a person skilled in the art better understand the present invention, the following first explains some technical terms that appear in the embodiments of the present invention as follows:

Transaction: refers to exchange of value of money and services between two parties. The embodiments of the present invention refer not only to a currency payment behavior, but also include, for example, a behavior in which a merchant provides a discount coupon to a customer.

Two-dimensional code: also referred to as a two-dimensional barcode. A common two-dimensional code is QR code, and QR is short for quick response. It is an ultra-popular coding mode on a mobile device in recent years. The two-dimensional code can store more information and indicate more data types than a conventional barcode.

Barcode: a graphic identifier that arranges a plurality of black stripe s and blanks with different widths according to a particular encoding rule to express a group of information.

APP: An application is application software on an application platform, such as application software on a Symbian platform, a Microsoft platform, a Google platform, and an Apple iOS platform.

GPS: short for Global Positioning System.

URL: Uniform Resource Locator is a concise representation of a resource location and an access method that can be obtained from the Internet, and is an address of a standard resource on the Internet.

In some embodiments of the present invention, a terminal may be implemented in various forms. For example, the terminal described in the present invention may include mobile terminals such as a mobile phone, a smartphone, a notebook computer, a digital broadcast receiver, a personal digital assistance (PDA), a tablet computer (PAD), a portable media player (PMP), and a navigation apparatus and fixed terminals such as a digital TV and a desktop computer. It is assumed that a terminal is a mobile terminal below. However, a person skilled in the art should understand that, unless an element particularly used for a mobile purpose, a construction according to an implementation of the present invention can also be applied to a terminal of a fixed type.

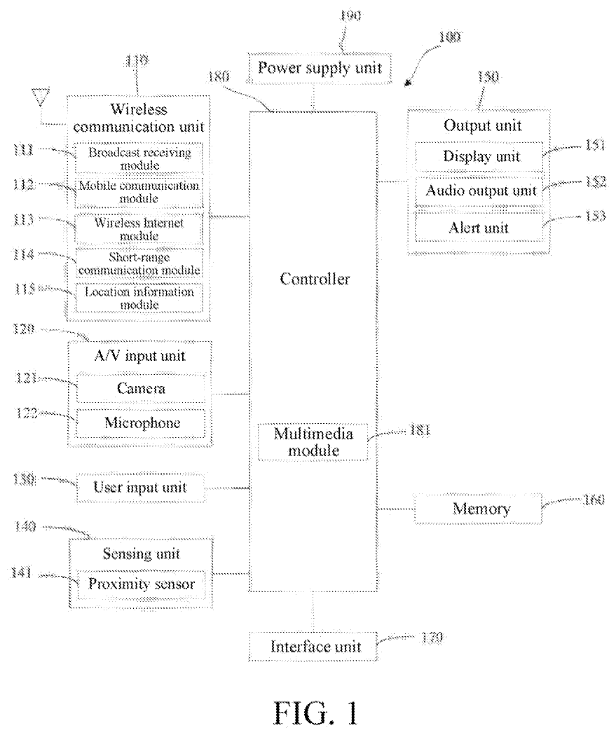

FIG. 1 is a schematic structural diagram of hardware of an optional mobile terminal according to embodiments of the present invention.

A mobile terminal 100 includes a wireless communication unit 110, an audio/video (A/V) input unit 120, a user input unit 130, a sensing unit 140, an output unit 150, a memory 160, an interface unit 170, a controller 180, a power supply unit 190, and the like. FIG. 1 shows a mobile terminal with various components, but it should be understood that, not all shown components are required to be implemented. More or fewer components may be alternatively implemented. Elements of the mobile terminal are described below in detail.

The wireless communication unit 110 generally includes one or more components, and allows radio communication between the mobile terminal 100 and a wireless communication system or a network. For example, the wireless communication unit may include at least one of a broadcast receiving module 111, a mobile communication module 112, a wireless Internet module 113, a short-range communication module 114, or a location information module 115.

The broadcast receiving module 111 receives a broadcast signal from an external broadcast management server and/or broadcasts related information by using a broadcast channel. The broadcast channel may include a satellite channel and/or a ground channel. The broadcast management server may be a server that generates and sends a broadcast signal and/or broadcasts related information, or a server that receives a previously generated broadcast signal and/or broadcasts related information and sends the related information to a terminal. The broadcast signal may include a TV broadcast signal, a radio broadcast signal, a data broadcast signal, or the like. In addition, the broadcast signal may further include a broadcast signal combined with a TV broadcast signal or a radio broadcast signal. The broadcast of the related information may also be provided by using a mobile communication network, and in this case, the broadcast related information may be received by the mobile communication module 112. The broadcast signal may exist in various forms. For example, the broadcast signal may exist in a form such as an electronic program guide (EPG) of Digital Multimedia Broadcasting (DMB) or an electronic service guide (ESG) of Digital Video Broadcasting-Handheld (DVB-H). The broadcast receiving module 111 may receive a signal broadcast by using various types of broadcast systems. Particularly, the broadcast receiving module 111 may receive a digital broadcast by using a data broadcast system for, for example, Digital Multimedia Broadcasting-Terrestrial (DMB-T), Digital Multimedia Broadcasting-Satellite (DMB-Step), Digital Video Broadcasting-Handheld (DVB-H), or Forward Link Only (MediaFLO®), or by using a digital broadcast system for, for example, Integrated Services Digital Broadcasting-Terrestrial (ISDB-T). The broadcast receiving module 111 may be configured to be suitable for various broadcast systems providing broadcast signals and the foregoing digital broadcast systems. A broadcast signal and/or broadcast related information received by using the broadcast receiving module 111 may be store in the memory 160 (or a storage medium of another type).

The mobile communication module 112 sends a radio signal to or receives a radio signal from any one of a base station (for example, an access point or a node B), an external terminal, or a server. Such a radio signal may include a voice communication signal, a video communication signal, or various types of data sent and/or received according to a text message and/or a multimedia message.

The wireless Internet module 113 supports wireless Internet access of the mobile terminal. The module may be internally or externally coupled to the terminal. A wireless Internet access technology involved in the module may include a wireless local area network (WLAN), Wireless Fidelity (WiFi), wireless broadband (Wibro), Worldwide Interoperability for Microwave Access (WiMAX), or High Speed Downlink Packet Access (HSDPA).

The short-range communication module 114 is a module configured to support short-range communication. Some examples of short-range communication technologies include Bluetooth™, radio frequency identification (RFID), Infrared Data Association (IrDA), ultra-wideband (UWB), and ZigBee™.

The location information module 115 is a module configured to check or obtain location information of the mobile terminal. A typical example of the location information module is the Global Positioning System (GPS). According to existing technologies, the GPS module 115 calculates distance information and accurate time information from three or more satellites, and applies a triangulation method to the calculated information, so as to accurately calculate current location information according to a longitude, a latitude, and a height. Currently, in a method for calculating the location information and the time information, three satellites are used and another satellite is used to rectify errors in the calculated location information and time information. In addition, the GPS module 115 can calculate speed information by continuously calculating the current location information in real time.

The A/V input unit 120 is configured to receive an audio signal or a video signal. The A/V input unit 120 may include a camera 121 and a microphone 122, and the camera 121 processes image data of a static picture or a video obtained by an image capture apparatus in a video capture mode or an image capture mode. The processed image frame may be displayed on the display unit 151. An image frame processed by the camera 121 may be stored in the memory 160 (or another storage medium) or sent via the wireless communication unit 110, and two or more cameras 121 may be provided according to the construction of the mobile terminal. The microphone 122 may receive sound (audio data) in a running mode such as a phone talk mode, a recording mode, or a voice identification mode, and can process the sound into audio data. The audio (voice) data that has been processed may be converted, in the telephone call mode, into a format that can be sent to a mobile communication base station by using the mobile communication module 112 and be output. The microphone 122 may implement various types of noise cancellation (or suppression) algorithms to cancel (or suppress) noise or interference generated in a process of receiving and sending an audio signal.

The user input unit 130 may generate key input data according to a command input by a user, to control various operations of the mobile terminal. The user input unit 130 allows the user to input various types of information, and may include a keyboard, a metal dome, a touch panel (for example, a touch-sensitive component that detects a change in resistance, press, capacitance, or the like resulted from a touch), a wheel, a joystick, and the like. Particularly, when the touchpad overlays the display unit 151 in a layer form, a touch screen may be formed.

The sensing unit 140 detects a current state of the mobile terminal 100 (for example, an open or closed state of the mobile terminal 100), a position of the mobile terminal 100, whether there is a touch (that is, a touch input) of the user on the mobile terminal 100, an orientation of the mobile terminal 100, an acceleration or deceleration movement and direction of the mobile terminal 100, or the like, and generates a command or a signal used to control an operation of the mobile terminal 100. For example, when the mobile terminal 100 is implemented as a slide-type mobile phone, the sensing unit 140 may sense whether the slide-type phone is being opened or closed. In addition, the sensing unit 140 can detect whether the power supply unit 190 provides power or whether the interface unit 170 is coupled to an external apparatus.

The interface unit 170 is used as an interface through which at least one external apparatus may be connected to the mobile terminal 100. For example, the external apparatus may include a wired or wireless headset port, an external power supply (or a battery charger) port, a wired or wireless data port, a storage card port, a port used to connect an apparatus having an identification module, an audio input/output (I/O) port, a video I/O port, an earphone port, and the like. The identification module may store various information used to authenticate the user when the user uses the mobile terminal 100, and may include a user identification module (UIM), a subscriber identification module (SIM), a universal subscriber identification module (USIM), or the like. In addition, the apparatus with an identification module (referred to as an “identification apparatus” below) may use a smart card form. Therefore, the identification apparatus may be connected to the mobile terminal 100 via a port or another connection apparatus. The interface unit 170 may be configured to receive an input (such as data information or electric power) from an external apparatus and transmit the received input to one or more elements in the mobile terminal 100 or may be configured to transmit data between the mobile terminal and an external apparatus.

In addition, when the mobile terminal 100 is connected to an external base, the interface unit 170 may be used as a path allowing providing electric power from the base to the mobile terminal 100 or may be used as a path allowing various command signals input from the base to be transmitted to the mobile terminal. The various command signals input from the base or the electric power may be used as signals used to identify whether the mobile terminal is accurately installed on the base. The output unit 150 is configured to provide an output signal (for example, an audio signal, a video signal, an alert signal, or a vibration signal) in a visual, audio, and/or tactile manner. The output unit 150 may include a display unit 151, an audio output module 152, an alert unit 153, and the like.

The display unit 151 may display information processed in the mobile terminal 100. For example, when the mobile terminal 100 is in the telephone call mode, the display unit 151 may display a user interface (UI) or a graphical user interface (GUI) related to a call or other communications (for example, text message receiving and sending and multimedia file downloading). When the mobile terminal 100 is in a video talk mode or an image capture mode, the display unit 151 may display a captured image and/or a received image, and show the video or image and a UI or a GUI of a related function, and the like.

In addition, when the display unit 151 and the touch panel are superposed on each other in the form of layers to form a touchscreen, the display unit 151 may be used as an input apparatus and an output apparatus. The display unit 151 may include at least one of a liquid crystal display (LCD), a thin film transistor liquid crystal display (TFT-LCD), an organic light emitting diode (OLED) display, a flexible display, or a three-dimensional (3D) display. Some of these displays may be constructed as transparent to allow a user to view the displays from the outside, which can be referred to as transparent displays. A typical transparent display may be, for example, a transparent organic light emitting diode (TOLED) display. According to a specific expected implementation, the mobile terminal 100 may include two or more display units (or other display apparatuses). For example, the mobile terminal may include an external display unit (not shown) and an internal display unit (not shown). The touchscreen may be configured to detect a touch input press and a touch input position and a touch input area.

When the mobile terminal is in a mode such as a call signal receiving mode, a talk mode, a recording mode, a voice identification mode, or a broadcast receiving mode, the audio output module 152 may transfer the audio data received by the wireless communication unit 110 or stored in the memory 160 into an audio signal and output the audio signal as sound. Moreover, the audio output module 152 may provide an audio output (such as call signal receiving sound or message receiving sound) related to a specific function executed by the mobile terminal 100. The audio output module 152 may include a loudspeaker, a buzzer, or the like.

The alert unit 153 may provide an output to notify the mobile terminal 100 of occurrence of an event. A typical event may include call receiving, message receiving, a key signal input, a touch input, or the like. In addition to an audio output or a video output, the alert unit 153 may provide an output in different forms to notify occurrence of an event. For example, the alert unit 153 may provide an output in the form of a vibration. When receiving a call, a message, or some other incoming communications, the alert unit 153 may provide a tactile output (that is, a vibration) to notify the user of the event. By providing such a tactile output, even when a mobile phone of a user is in a pocket of the user, the user can still identify occurrences of various events. The alert unit 153 may also provide, by using the display unit 151 or the audio output module 152, an output notifying occurrence of an event.

The memory 160 may store a software program that is executed by a controller 180 to process and control operations, or the like, or may temporarily store data (for example, a telephone book, a message, a static image, or a video) that has been output or to be output. In addition, the memory 160 may store data of various forms of vibrations and audio signals that are output when touches are applied to the touchscreen.

The memory 160 may include at least one type of storage medium. The storage medium includes a flash memory, a hard disk drive, a multimedia card, a card-type memory (for example, an SD memory or a DX memory), a random access memory (RAM), a static random access memory (SRAM), a read-only memory (ROM), an electrically erasable programmable read only memory (EEPROM), a programmable read-only memory (PROM), a magnetic memory, a magnetic disk, an optical disk, or the like. Moreover, the mobile terminal 100 may be connected, by means of a network, to a network storage apparatus that executes a storage function of the memory 160 for cooperation.

The controller 180 generally controls total operations of the mobile terminal. For example, the controller 180 performs control and processing related to a voice call, data communication, a video call, or the like. In addition, the controller 180 may include a multimedia module 181 configured to reproduce (or replay) multimedia data. The multimedia module 181 may be constructed inside the controller 180, or may be constructed as separate from the controller 180. The controller 180 may perform pattern recognition processing, to recognize a handwriting input or a picture drawing input performed on the touchscreen as a character or an image.

Under the control of the controller 180, the power supply unit 190 receives external power or internal power and provides suitable power for operating the elements and the components.

The various implementations described herein may be implemented by using, for example, a computer readable medium including computer software, computer hardware, or any combination thereof. For a hardware implementation, the implementations described herein may be implemented by using at least one of an application-specific integrated circuit (ASIC), a digital signal processor (DSP), a digital signal processing device (DSPD), a programmable logic device (PLD), a field programmable gate array (FPGA), a processor, a controller, a microcontroller, a microprocessor, an electronic unit designed to perform the function described herein. In some cases, such an implementation may be implemented in the controller 180. For a software implementation, an implementation of a process or a function may be implemented by using a separate software module that allows at least one function or operation to be performed. Software code may be implemented by a software application program (or program) compiled by any suitable programming language, and the software code may be stored in the memory 160 and executed by the controller 180.

So far, the mobile terminal has been described according to functions. For ease of description, among various types of mobile terminals such as a folded type, a straight type, a swinging type, and a sliding type mobile terminal, the following describes the sliding type mobile terminal as an example. Therefore, the present invention can be applied to any type of mobile terminal, and is not limited to the sliding type mobile terminal.

The embodiments of the method of the present invention are provided based on the hardware structure of the mobile terminal.

In the electronic transaction field, in some specific scenarios, both parties involved in scanning a two-dimensional code for payment or obtaining information are required in a specific area, such as a scenario in which a face-to-face transaction is required. For example, to attract offline customer traffic for a specific entity store, an activity for scanning a specific two-dimensional code of the entity store to obtain a discount coupon is proposed. However, a current payment mechanism does not perform area verification on locations of both payment parties. Therefore, it cannot be ensured that a transaction is completed in a specific area, and therefore, a malicious transaction, a fake order, and tax evasion are easily triggered in a non-specific area. For example, a merchant does not provide a two-dimensional code to a customer in a non-specific scenario according to a requirement of a partner or a government, so as to perform a transaction (including collecting or paying an electronic currency, or providing a discount coupon to the customer). Therefore, there may be an act of the merchant making a fake order, which is not conducive to supervision, and even there may be an act of the merchant operating in a different place, leading to tax evasion.

To overcome the above problems, it is necessary to verify whether parties involved in a transaction are in a specific area.

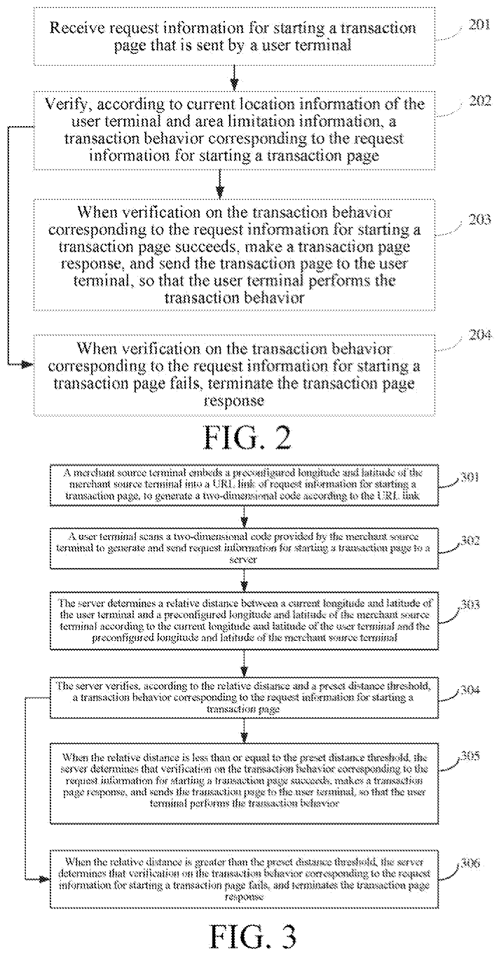

As shown in FIG. 2, an embodiment of the present invention provides a transaction verification method, including:

Step 201: Receive request information for starting a transaction page that is sent by a user terminal.

The request information for starting a transaction page includes current location information of the user terminal and area limitation information preconfigured for the transaction page.

Step 202: Verify, according to the current location information of the user terminal and the area limitation information, a transaction behavior corresponding to the request information for starting a transaction page.

Step 203: When verification on the transaction behavior corresponding to the request information for starting a transaction page succeeds, make a transaction page response, and send the transaction page to the user terminal, so that the user terminal performs the transaction behavior.

Step 204: When verification on the transaction behavior corresponding to the request information for starting a transaction page fails, terminate the transaction page response.

To make a person skilled in the art better understand the present invention, the following lists a more detailed embodiment. It should be noted that a transaction code in this embodiment of the present invention may be a two-dimensional code (but is not limited thereto, for example, may also be a barcode). The current location information of the user terminal includes a current longitude and latitude of the user terminal, and may be determined by using a GPS set in the user terminal. The preconfigured location information of the merchant source terminal includes a preconfigured longitude and latitude of the merchant source terminal, for example, may be a longitude and latitude of a business address registered by the merchant.

As shown in FIG. 3, an embodiment of the present invention provides a transaction verification method, including:

Step 301: A merchant source terminal embeds a preconfigured longitude and latitude of the merchant source terminal into a URL link of request information for starting a transaction page, to generate a two-dimensional code according to the URL link.

Optionally, a format of the preconfigured longitude and latitude of the merchant source terminal may be set to ddmm.mmmm, that is, indicates dd degrees mm.mmmm minutes. For example, if the URL link is originally https://request.info/, and the preconfigured longitude and latitude of the merchant source terminal are that the north latitude is 39 degrees 31.4449 minutes and the east longitude is 116 degrees 43.5123 minutes, after the preconfigured longitude and latitude of the merchant source terminal is embedded into the URL link, a new URL link may be https://request.info/GPS.N.3931.4449.E.11643.5123. Therefore, the two-dimensional code may be generated according to the new URL link, so that the two-dimensional code carries the preconfigured longitude and latitude information of the merchant source terminal.

Step 302: A user terminal scans a two-dimensional code provided by the merchant source terminal to generate and send request information for starting a transaction page to a server.

The request information for starting a transaction page includes current location information of the user terminal (for example, a current longitude and latitude of the user terminal are determined by using a GPS set in the user terminal) and area limitation information preconfigured for the transaction page. The area limitation information includes preconfigured location information of the merchant source terminal (for example, a preconfigured longitude and latitude of the merchant source terminal).

Step 303: The server determines a relative distance between the current longitude and latitude of the user terminal and the preconfigured longitude and latitude of the merchant source terminal according to the current longitude and latitude of the user terminal and the preconfigured longitude and latitude of the merchant source terminal.

Herein, in step 303, the determining a relative distance between the current longitude and latitude of the user terminal and the preconfigured longitude and latitude of the merchant source terminal according to the current longitude and latitude of the user terminal and the preconfigured longitude and latitude of the merchant source terminal may be implemented in the following manner, for example:

determining a latitude difference α and a longitude difference β between the current longitude and latitude of the user terminal and the preconfigured longitude and latitude of the merchant source terminal according to the current longitude and latitude {LatitB, LongitB} of the user terminal and the preconfigured longitude and latitude {LatitA, LongitA} of the merchant source terminal by using a formula:

$$\{ \begin{matrix}α = deg 2 rad ( LatitA ) - deg 2 rad ( L a titB ) \\ β = deg 2 rad ( L o n gitA ) - deg 2 rad ( L o n gitB )\end{matrix} ,$$

where LatitB is the current latitude of the user terminal, LongitB is the current longitude of the user terminal, LatitA is the preconfigured latitude of the merchant source terminal, and LongitA is the preconfigured longitude of the merchant source terminal; and deg2rad(x) represents an angle conversion radian function, where

$$deg 2 rad ( x ) = \frac{π}{180} \cdot x ;$$

and

then determine, according to the latitude difference α and the longitude difference β, a relative distance S between the current longitude and latitude of the user terminal and the preconfigured longitude and latitude of the merchant source terminal;

where,

$$S = 2 * arcsin \sqrt{{( sin \frac{α}{2} )}^{2} + cos ( LongitA ) * cos ( LongitB ) * {( sin \frac{β}{2} )}^{2}} * R ,$$

and R is an equivalent earth radius, for example, 6378.137 km may be used, but is not limited.

Step 304: The server verifies, according to the relative distance and a preset distance threshold, a transaction behavior corresponding to the request information for starting a transaction page.

The distance threshold is an adjustable system parameter, and may be adjusted according to different service scenarios, which indicates a severity of a distance requirement between the merchant source terminal and the user terminal. For example, a value may be 0.5 km, but is not limited.

Step 305: When the relative distance is less than or equal to the preset distance threshold, the server determines that verification on the transaction behavior corresponding to the request information for starting a transaction page succeeds, makes a transaction page response, and sends the transaction page to the user terminal, so that the user terminal performs the transaction behavior.

For example, when the relative distance is less than or equal to the preset distance threshold, it indicates that the user terminal and the merchant source terminal are at a same location or within a specific area allowed by an error, and it is determined that verification on the transaction behavior corresponding to the request information for starting a transaction page succeeds. Further, a transaction page response may be made, and the transaction page is sent to the user terminal, so that the user terminal can perform a normal transaction behavior according to the transaction page, for example, perform a transaction such as making payment, obtaining a bonus point, obtaining a discount coupon, and obtaining a voucher.

Step 306: When the relative distance is greater than the preset distance threshold, the server determines that verification on the transaction behavior corresponding to the request information for starting a transaction page fails, and terminates the transaction page response.

For example, when the relative distance is greater than the preset distance threshold, it indicates that a location difference between the user terminal and the merchant source terminal is relatively large, and it is determined that verification on the transaction behavior corresponding to the request information for starting a transaction page fails, so that the transaction page response is terminated. That is, the server does not provide a normal transaction page for the user terminal. For example, the server may send a prompt message indicating a transaction page retrieval failure to the user terminal.

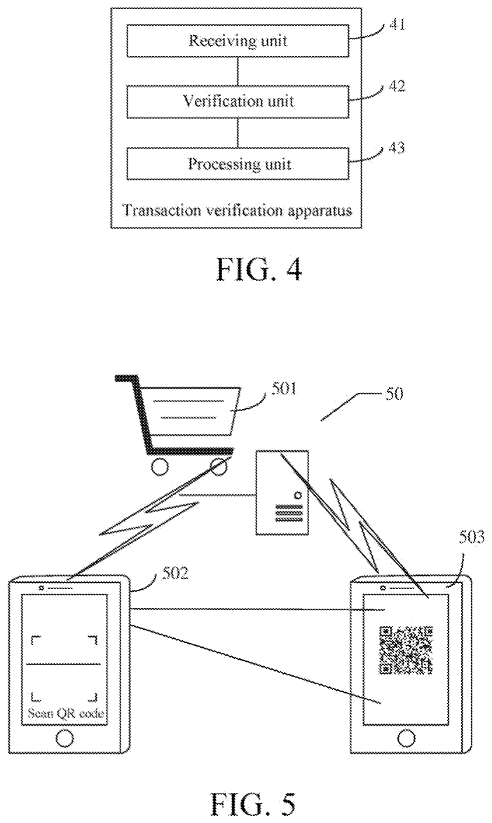

As shown in FIG. 4, an embodiment of the present invention further provides a transaction verification apparatus, including:

a receiving unit 41, configured to receive request information for starting a transaction page that is sent by a user terminal, where the request information for starting a transaction page includes current location information of the user terminal and area limitation information preconfigured for the transaction page;

a verification unit 42, configured to verify, according to the current location information of the user terminal and the area limitation information, a transaction behavior corresponding to the request information for starting a transaction page; and

a processing unit 43, configured to: when verification on the transaction behavior corresponding to the request information for starting a transaction page succeeds, make a transaction page response, and send the transaction page to the user terminal, so that the user terminal performs the transaction behavior; and when verification on the transaction behavior corresponding to the request information for starting a transaction page fails, terminate the transaction page response.

As shown in FIG. 5, an embodiment of the present invention further provides a transaction verification system 50, including:

a server 501 and a user terminal 502, where the user terminal 502 is communicatively connected to the server 501.

The server 501 is configured to receive request information for starting a transaction page that is sent by the user terminal 502, where the request information for starting a transaction page includes current location information of the user terminal and area limitation information preconfigured for the transaction page; verify, according to the current location information of the user terminal and the area limitation information, a transaction behavior corresponding to the request information for starting a transaction page; when verification on the transaction behavior corresponding to the request information for starting a transaction page succeeds, make a transaction page response, and send the transaction page to the user terminal 502, so that the user terminal 502 performs the transaction behavior; and when verification on the transaction behavior corresponding to the request information for starting a transaction page fails, terminate the transaction page response.

Further, as shown in FIG. 5, the transaction verification system 50 further includes a merchant source terminal 503 communicatively connected to the server 501.

The user terminal 502 is configured to scan a transaction code provided by the merchant source terminal 503, generate and send request information for starting a transaction page to the server 501, where the request information for starting a transaction page includes current location information of the user terminal and area limitation information preconfigured for the transaction page, and the area limitation information includes preconfigured location information of the merchant source terminal.

In addition, the transaction code includes a two-dimensional code; the current location information of the user terminal includes a current longitude and latitude of the user terminal; and the preconfigured location information of the merchant source terminal includes a preconfigured longitude and latitude of the merchant source terminal;

the merchant source terminal 503 is specifically configured to embed the preconfigured longitude and latitude of the merchant source terminal into a URL link of the request information for starting a transaction page, and generate the two-dimensional code according to the URL link; and

the user terminal 502 is specifically configured to scan a two-dimensional code provided by the merchant source terminal 503, generate request information for starting a transaction page, and send the request information for starting a transaction page to the server 501.

Specifically, the transaction code includes a two-dimensional code; the current location information of the user terminal includes a current longitude and latitude of the user terminal; and the preconfigured location information of the merchant source terminal includes a preconfigured longitude and latitude of the merchant source terminal; and

The server 501 is specifically configured to: determine a relative distance between the current longitude and latitude of the user terminal and the preconfigured longitude and latitude of the merchant source terminal according to the current longitude and latitude of the user terminal and the preconfigured longitude and latitude of the merchant source terminal; and; and verify, according to the relative distance and a preset distance threshold, the transaction behavior corresponding to the request information for starting a transaction page; and when the relative distance is less than or equal to the preset distance threshold, determine that verification on the transaction behavior corresponding to the request information for starting a transaction page succeeds; or when the relative distance is greater than the preset distance threshold, determine that verification on the transaction behavior corresponding to the request information for starting a transaction page fails.

In addition, the server 501 is specifically configured to:

determine a latitude difference α and a longitude difference β between the current longitude and latitude of the user terminal and the preconfigured longitude and latitude of the merchant source terminal according to the current longitude and latitude {LatitB, LongitB} of the user terminal and the preconfigured longitude and latitude {LatitA, LongitA} of the merchant source terminal by using a formula:

$$\{ \begin{matrix}α = deg 2 rad ( LatitA ) - deg 2 rad ( L a titB ) \\ β = deg 2 rad ( L o n gitA ) - deg 2 rad ( L o n gitB )\end{matrix} ,$$

where LatitB is the current latitude of the user terminal, LongitB is the current longitude of the user terminal, LatitA is the preconfigured latitude of the merchant source terminal, and LongitA is the preconfigured longitude of the merchant source terminal; and deg2rad(x) represents an angle conversion radian function, where

$$deg 2 rad ( x ) = \frac{π}{180} \cdot x ;$$

and

determine, according to the latitude difference α and the longitude difference β, a relative distance S between the current longitude and latitude of the user terminal and the preconfigured longitude and latitude of the merchant source terminal;

where,

$$S = 2 * arcsin \sqrt{{( sin \frac{α}{2} )}^{2} + cos ( LongitA ) * cos ( LongitB ) * {( sin \frac{β}{2} )}^{2}} * R ,$$

and R is an equivalent earth radius.

In addition, the present invention further provides a computer readable storage medium, including a program or instructions. When the program or the instructions run on a computer, the foregoing transaction verification methods in FIG. 2 and FIG. 3 are implemented.

In addition, the present invention further provides a computer program product that includes instructions. When the computer program product runs on a computer, the computer executes the transaction verification methods in FIG. 2 and FIG. 3.

In addition, the present invention further provides a chip system, including a processor, the processor coupled to a memory, where the memory stores program instructions, and when the program instructions stored in the memory are executed by the processor, the foregoing transaction verification methods in FIG. 2 and FIG. 3 are implemented.

In addition, the present invention further provides a circuit system, where the circuit system includes a processing circuit, and the processing circuit is configured to execute the foregoing transaction verification methods in FIG. 2 and FIG. 3.

In addition, the present invention further provides a computer server, including a memory and one or more processors that are communicatively connected to the memory.

The memory stores instructions that may be executed by one or more processors, and the instructions are executed by the one or more processors, so that the one or more processors implement the foregoing transaction verification methods in FIG. 2 and FIG. 3.

According to the transaction verification method, apparatus, and system provided in the embodiments of the present invention, the current location information of the user terminal and the area limitation information preconfigured for the transaction page can be obtained from the request information for starting a transaction page that is sent by the user terminal. Further, the transaction behavior corresponding to the request information for starting a transaction page may be verified. In this way, a transaction can be completed in a specific area, and a malicious transaction, a fake order, and tax evasion in a non-specific area can be avoided.

A person skilled in the art should understand that the embodiments of the present invention may be provided as a method, a system, or a computer program product. Therefore, the present invention may be in a form of complete hardware embodiments, complete software embodiments, or embodiments combining software and hardware. Moreover, the present invention may use a form of a computer program product that is implemented on one or more computer-usable storage media (including but not limited to a disk memory, a CD-ROM, an optical memory, and the like) that include computer-usable program code.

The present invention is described with reference to flowcharts and/or block diagrams of the method, device (system), and computer program product in the embodiments of the present invention. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of any other programmable data processing device to generate a machine, so that the instructions executed by a computer or a processor of any other programmable data processing device generate a device for implementing a function in one or more processes in the flowcharts and/or in one or more blocks in the block diagrams.

These computer program instructions may also be stored in a computer readable memory that can guide a computer or another programmable data processing device to work in a specific manner, so that the instructions stored in the computer readable memory generate a product including an instruction apparatus, where the instruction apparatus implements functions specified in one or more procedures in the flowcharts and/or one or more blocks in the block diagrams.

These computer program instructions may also be loaded onto a computer or another programmable data processing device, so that a series of operations and steps are performed on the computer or the another programmable device, thereby generating computer-implemented processing. Therefore, the instructions executed on the computer or the another programmable device provide steps for implementing a specific function in one or more processes in the flowcharts and/or in one or more blocks in the block diagrams.

The transaction verification method and system provided in the present invention are described in detail above. For those of ordinary skill in the art, any obvious change made to the present invention without departing from the essential content of the present invention shall fall within the protection scope of the patent of the present invention.

What is claimed is:

1. A transaction verification method, comprising the following steps:
receiving request information for starting a transaction page that is sent by a user terminal, wherein the request information for starting a transaction page comprises current location information of the user terminal and area limitation information preconfigured for the transaction page;
verifying, according to the current location information of the user terminal and the area limitation information, a transaction behavior corresponding to the request information for starting a transaction page; and
when verification on the transaction behavior corresponding to the request information for starting a transaction page succeeds, making a transaction page response, and sending the transaction page to the user terminal, so that the user terminal performs the transaction behavior;
and when verification on the transaction behavior corresponding to the request information for starting a transaction page fails, terminating the transaction page response.

2. The transaction verification method according to claim 1, wherein the receiving request information for starting a transaction page that is sent by a user terminal comprises:
receiving request information for starting a transaction page that is generated by the user terminal by scanning a transaction code, wherein the request information for starting a transaction page comprises current location information of the user terminal and area limitation information preconfigured for the transaction page, and the area limitation information comprises preconfigured location information of a merchant source terminal.

3. The transaction verification method according to claim 2, wherein the transaction code comprises a two-dimensional code; the current location information of the user terminal comprises a current longitude and latitude of the user terminal; and the preconfigured location information of the merchant source terminal comprises a preconfigured longitude and latitude of the merchant source terminal; and
the receiving request information for starting a transaction page that is generated by the user terminal by scanning a transaction code comprises:
receiving request information for starting a transaction page that is generated by the user terminal by scanning a two-dimensional code, wherein the preconfigured longitude and latitude of the merchant source terminal in the request information for starting a transaction page are from the two-dimensional code; and the two-dimensional code is generated according to a URL link after the preconfigured longitude and latitude of the merchant source terminal are embedded in the URL link in the request information for starting a transaction page.

4. The transaction verification method according to claim 2, wherein the transaction code comprises a two-dimensional code; and the current location information of the user terminal comprises a current longitude and latitude of the user terminal;
the preconfigured location information of the merchant source terminal comprises a preconfigured longitude and latitude of the merchant source terminal; and
the verifying, according to the current location information of the user terminal and the area limitation information, a transaction behavior corresponding to the request information for starting a transaction page comprises:
determining a relative distance between the current longitude and latitude of the user terminal and the preconfigured longitude and latitude of the merchant source terminal according to the current longitude and latitude of the user terminal and the preconfigured longitude and latitude of the merchant source terminal; and
verifying, according to the relative distance and a preset distance threshold, the transaction behavior corresponding to the request information for starting a transaction page; and when the relative distance is less than or equal to the preset distance threshold, determining that verification on the transaction behavior corresponding to the request information for starting a transaction page succeeds; or when the relative distance is greater than the preset distance threshold, determining that verification on the transaction behavior corresponding to the request information for starting a transaction page fails.

5. The transaction verification method according to claim 4, wherein the determining a relative distance between the current longitude and latitude of the user terminal and the preconfigured longitude and latitude of the merchant source terminal according to the current longitude and latitude of the user terminal and the preconfigured longitude and latitude of the merchant source terminal comprises:
determining a latitude difference α and a longitude difference β between the current longitude and latitude of the user terminal and the preconfigured longitude and latitude of the merchant source terminal according to the current longitude and latitude {LatitB, LongitB} of the user terminal and the preconfigured longitude and latitude {LatitA, LongitA} of the merchant source terminal by using a formula:
$$\{ \begin{matrix}α = deg 2 rad ( LatitA ) - deg 2 rad ( L a titB ) \\ β = deg 2 rad ( L o n gitA ) - deg 2 rad ( L o n gitB )\end{matrix} ,$$
wherein LatitB is the current latitude of the user terminal, LongitB is the current longitude of the user terminal, LatitA is the preconfigured latitude of the merchant source terminal, and LongitA is the preconfigured longitude of the merchant source terminal; and deg2rad(x) represents an angle conversion radian function, where
$$deg 2 rad ( x ) = \frac{π}{180} \cdot x ;$$
and
determining, according to the latitude difference α and the longitude difference β, a relative distance S between the current longitude and latitude of the user terminal and the preconfigured longitude and latitude of the merchant source terminal;
wherein,
$$S = 2 * arcsin \sqrt{{( sin \frac{α}{2} )}^{2} + cos ( LongitA ) * cos ( LongitB ) * {( sin \frac{β}{2} )}^{2}} * R ,$$
and R is an equivalent earth radius.

6. A transaction verification system, comprising a server and a user terminal, wherein the user terminal is communicatively connected to the server;
the server is configured to receive request information for starting a transaction page that is sent by a user terminal, wherein the request information for starting a transaction page comprises current location information of the user terminal and area limitation information preconfigured for the transaction page; verify, according to the current location information of the user terminal and the area limitation information, a transaction behavior corresponding to the request information for starting a transaction page; when verification on the transaction behavior corresponding to the request information for starting a transaction page succeeds, make a transaction page response, and send the transaction page to the user terminal, so that the user terminal performs the transaction behavior; and when verification on the transaction behavior corresponding to the request information for starting a transaction page fails, terminate the transaction page response.

7. The transaction verification system according to claim 6, further comprising a merchant source terminal communicatively connected to the server; and
the user terminal is configured to scan a transaction code provided by the merchant source terminal, generate and send request information for starting a transaction page to the server, wherein the request information for starting a transaction page comprises current location information of the user terminal and area limitation information preconfigured for the transaction page, and the area limitation information comprises preconfigured location information of the merchant source terminal.

8. The transaction verification system according to claim 7, wherein the transaction code comprises a two-dimensional code; the current location information of the user terminal comprises a current longitude and latitude of the user terminal; and the preconfigured location information of the merchant source terminal comprises a preconfigured longitude and latitude of the merchant source terminal;
the merchant source terminal is specifically configured to embed the preconfigured longitude and latitude of the merchant source terminal into a URL link of the request information for starting a transaction page, and generate the two-dimensional code according to the URL link; and
the user terminal is specifically configured to scan a two-dimensional code provided by the merchant source terminal, generate request information for starting a transaction page, and send the request information for starting a transaction page to the server.

9. The transaction verification system according to claim 7, wherein the transaction code comprises a two-dimensional code; the current location information of the user terminal comprises a current longitude and latitude of the user terminal; and the preconfigured location information of the merchant source terminal comprises a preconfigured longitude and latitude of the merchant source terminal; and
the server is specifically configured to:
determine a relative distance between the current longitude and latitude of the user terminal and the preconfigured longitude and latitude of the merchant source terminal according to the current longitude and latitude of the user terminal and the preconfigured longitude and latitude of the merchant source terminal; and
verify, according to the relative distance and a preset distance threshold, the transaction behavior corresponding to the request information for starting a transaction page; and when the relative distance is less than or equal to the preset distance threshold, determine that verification on the transaction behavior corresponding to the request information for starting a transaction page succeeds; or when the relative distance is greater than the preset distance threshold, determine that verification on the transaction behavior corresponding to the request information for starting a transaction page fails.

10. The transaction verification system according to claim 9, wherein the server is specifically configured to:
determine a latitude difference α and a longitude difference β between the current longitude and latitude of the user terminal and the preconfigured longitude and latitude of the merchant source terminal according to the current longitude and latitude {LatitB, LongitB} of the user terminal and the preconfigured longitude and latitude {LatitA, LongitA} of the merchant source terminal by using a formula:
$$\{ \begin{matrix}α = deg 2 rad ( LatitA ) - deg 2 rad ( L a titB ) \\ β = deg 2 rad ( L o n gitA ) - deg 2 rad ( L o n gitB )\end{matrix} ,$$
wherein LatitB is the current latitude of the user terminal, LongitB is the current longitude of the user terminal, LatitA is the preconfigured latitude of the merchant source terminal, and LongitA is the preconfigured longitude of the merchant source terminal; and deg2rad(x) represents an angle conversion radian function, where
$$deg 2 rad ( x ) = \frac{π}{180} \cdot x ;$$
and
determine, according to the latitude difference α and the longitude difference β, a relative distance S between the current longitude and latitude of the user terminal and the preconfigured longitude and latitude of the merchant source terminal;
wherein,
$$S = 2 * arcsin \sqrt{{( sin \frac{α}{2} )}^{2} + cos ( LongitA ) * cos ( LongitB ) * {( sin \frac{β}{2} )}^{2}} * R ,$$
and R is an equivalent earth radius.
